(19) United States
(12) Patent Application Publication
(10) Pub. No.: US 2020/0387813 A1
(43) Pub. Date: Dec. 10, 2020

(54) DYNAMICALLY ADAPTABLE RULES AND COMMUNICATION SYSTEM TO MANAGE PROCESS CONTROL-BASED USE CASES

(71) Applicant: TrustArc Inc, San Francisco, CA (US)

(72) Inventor: Hilary M. Wandall, Center Valley, PA (US)

(21) Appl. No.: 16/894,764

(22) Filed: Jun. 6, 2020

Related U.S. Application Data
(60) Provisional application No. 62/858,979, filed on Jun. 8, 2019.
(60) Provisional application No. 62/858,980, filed on Jun. 8, 2019.

(51) Int. Cl. G06N 5/04; G06N 5/02; G06N 20/00

(52) U.S. Cl. CPC G06N 5/04; G06N 20/00; G06N 5/027

(57) ABSTRACT

A method, system and/or computer usable program product for determining applicability of a set of use cases to an entity comprising the steps of receiving a dynamic profile of an entity, the profile including attributes of that entity; receiving a dynamic set of applicability rules, each set of applicability rules corresponding to at least one of the set of use cases, for determining whether the set of use cases applies to the entity based on the attributes of that entity; applying the dynamic set of applicability rules against the dynamic entity profile to determine whether the set of use cases is applicable to the entity; upon a positive determination that the at least one of the set of use cases is applicable to the entity, notifying a managing user of the positive determination; responsive to receiving an indication that the dynamic profile of the entity has been modified, automatically repeating the step of applying the dynamic set of applicability rules against the dynamic entity profile to determine whether the set of use cases is applicable to the entity and, upon the positive determination, automatically repeating the step of notifying the managing user; and responsive to receiving an indication that the dynamic set of applicability rules has been modified, automatically repeating the step of applying the dynamic set of applicability rules against the dynamic entity profile to determine whether the set of use cases is applicable to the entity and, upon the positive determination, automatically repeating the step of notifying the managing user.

### PRIORITY CLAIM

This application claims priority to U.S. Provisional Application No. 62/858,979, filed Jun. 8, 2019, entitled “DYNAMICALLY ADAPTABLE RULES AND COMMUNICATION SYSTEM TO MANAGE PROCESS CONTROL-BASED USE CASES”, and claims priority to U.S. Provisional Application No. 62/858,980, filed Jun. 8, 2019, entitled “DYNAMICALLY ADAPTABLE RULES AND COMMUNICATION SYSTEM FOR MANAGING PROCESS CONTROLS”, the disclosures of which are incorporated in their entirety herein by reference.

### BACKGROUND

### Technical Field

The present invention relates generally to a dynamically adaptable rules and communication system, and more specifically to a computer-implemented method for utilizing the dynamically adaptable rules system, including interconnected rules engines and databases to automatically manage process control-based use cases, including automatically determining the applicability of those use cases to an entity.

### Description of Related Art

With the advent of the internet and mass communications of data worldwide, a host of data management issues have arisen. Many entities are gaining and sharing access to an increasingly large variety of data types, including personal data, much of which may be sensitive. In addition, this is occurring among a proliferation of data privacy, security policies, export controls, etc. For example, various governments, standard bodies and other entities have instituted a large variety of laws, regulations or rules addressing and enforcing certain data management policies. As a result, it is becoming substantially more difficult to manage the use and sharing of data types while complying with a multitude of laws, regulations and rules.

Whether certain laws regulations or rules apply for a given use case depends on a variety of conditions including the type of entity, where the entity and its workers are located, the size of the entity, the type of data being accessed or shared, the location of where the data was accessed or shared, the sensitivity of the data, etc. As a result, just determining whether a certain law, regulation or rule applies is a complex and formidable task. In addition, if it is determined that a certain law, regulation of rule does not apply to a given entity, then that entity typically does not have to show compliance with that law, regulation or rule, thereby saving significant resources.

An example of mapping multiple governance, risk and compliance (GRC) mandates against each other in order to identify “common controls” is provided by the Unified Compliance Framework (UCF). UCF maintains a database of mandate “authority documents”, mandate citations, common controls and a defined terms dictionary. The UCF allows a user to input mandates of interest and to map the mandates on a one to one, one to many and many to many basis in order to produce a hierarchical list of common controls among the selected mandates. These common controls are linked to roles, assets, records, activities, events and audit questions. This list and related reports help UCF users identify overlaps among mandates, identify and remedy gaps in the user organization's GRC program and support a compliance audit program.

### SUMMARY

The illustrative embodiments of the present invention provide a method, system, and/or computer usable program product for determining applicability of a set of use cases to an entity comprising the steps of receiving a dynamic profile of an entity, the profile including attributes of that entity; receiving a dynamic set of applicability rules, each set of applicability rules corresponding to at least one of the set of use cases, for determining whether the set of use cases applies to the entity based on the attributes of that entity; applying the dynamic set of applicability rules against the dynamic entity profile to determine whether the set of use cases is applicable to the entity; upon a positive determination that the at least one of the set of use cases is applicable to the entity, notifying a managing user of the positive determination; responsive to receiving an indication that the dynamic profile of the entity has been modified, automatically repeating the step of applying the dynamic set of applicability rules against the dynamic entity profile to determine whether the set of use cases is applicable to the entity and, upon the positive determination, automatically repeating the step of notifying the managing user; and responsive to receiving an indication that the dynamic set of applicability rules has been modified, automatically repeating the step of applying the dynamic set of applicability rules against the dynamic entity profile to determine whether the set of use cases is applicable to the entity and, upon the positive determination, automatically repeating the step of notifying the managing user.

### BRIEF DESCRIPTION OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 provides a block diagram of an illustrative data processing system in which various embodiments of the present disclosure may be implemented;

FIG. 2 provides a block diagram of an illustrative network of data processing systems in which various embodiments of the present disclosure may be implemented;

FIG. 3 provides a high-level block diagram of a dynamically adaptable rules system, including multiple interacting modules utilized to manage process control-based use cases, in which various embodiments of the present disclosure may be implemented;

FIGS. 4A-4D provide high-level flow diagrams for each of the multiple interacting modules utilized to manage process control-based use cases in which various embodiments of the present disclosure may be implemented;

FIGS. 5A-5B provide block diagrams of types of database records utilized to manage process control-based use cases in which various embodiments of the present disclosure may be implemented;

FIG. 6 provides a block diagram of a graphical user interface User 3 may use to manage process control-based use cases in which various embodiments of the present disclosure may be implemented; and

FIG. 7 provides a flow diagram of the applicability engine managing process control-based use cases in which various embodiments of the present disclosure may be implemented.

### DETAILED DESCRIPTION

Processes and devices may be implemented and utilized for utilizing a dynamically adaptable rules and communication system to manage process control-based use cases. These processes and apparatuses may be implemented and utilized as will be explained with reference to the various embodiments below.

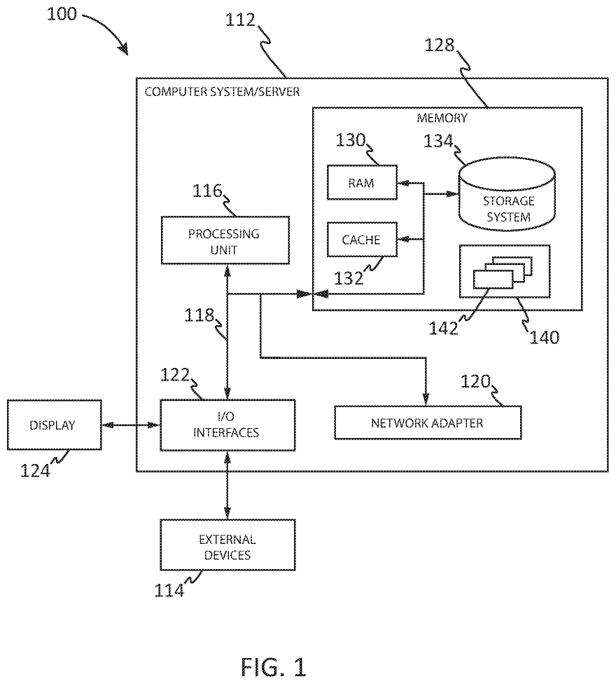

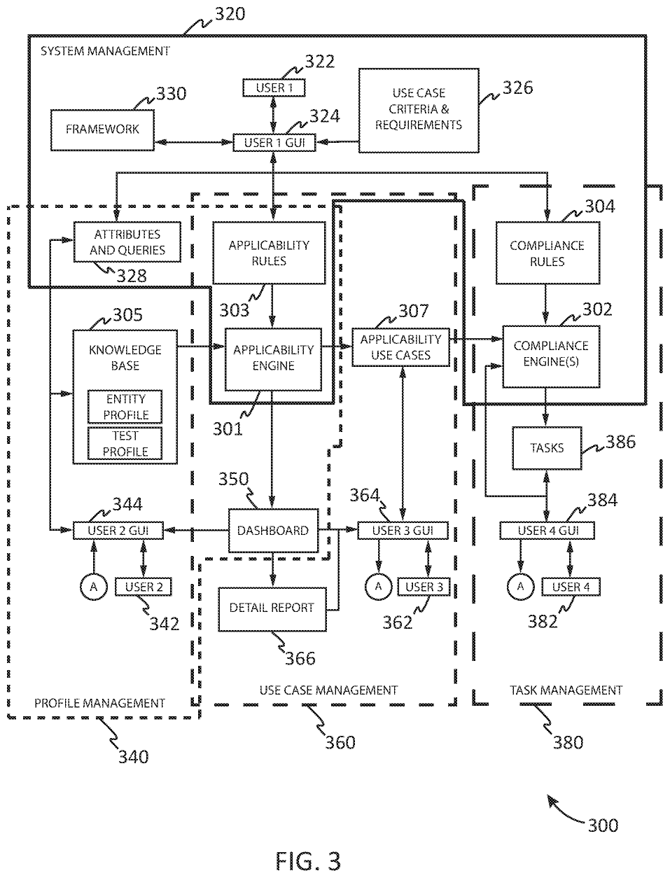

FIG. 1 provides a block diagram of an illustrative data processing system in which various embodiments of the present disclosure may be implemented. Data processing system 100 is one example of a suitable data processing system and is not intended to suggest any limitation as to the scope of use or functionality of the embodiments described herein. Regardless, data processing system 100 is capable of being implemented and/or performing any of the functionality set forth herein such as utilizing a dynamically adaptable rules and communication system to manage process control-based use cases. Use cases may include a variety of policies for managing the use and dissemination of certain types of data. These policies typically require the use of one or more sets of process controls for managing the use and dissemination of these types of data within or among corporate entities and individuals. These process controls may be specific controls required for managing certain processes or they may also be a set of criteria (i.e., standards) to be met by a set of controls for managing certain processes. For example, HIPAA (Health Insurance Portability and Accountability Act) is a law that does not mandate specific controls on limiting access to private medical information. Instead, the HIPAA Security and Privacy Rules set standards that need to be met, but the rules expressly provide that the particular controls a covered entity needs to adopt to meet those standards (e.g., the controls of 128-bit encryption and VPNs) are up to the covered entity to figure out. By way of contrast, ISO (International Organization for Standardization) 27001 is expressly control-based, since compliance with ISO 27001 requires implementation of specific technical controls set forth in ISO 27002. These policies may be generated by governmental bodies, standards organizations, within a corporate entity, or other possible sources. Some examples of use cases are provided below with reference to FIG. 3.

In data processing system 100 there is a computer system/server 112, which is operational with numerous other general purpose or special purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-performable instructions, such as program modules, being processed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of non-transitory computer system usable media. Such media may be any available media that is accessible by computer system/server 112, and it includes both volatile and non-volatile media, removable and non-removable media.

System memory 128 can include non-transitory computer system readable media in the form of volatile memory, such as random-access memory (RAM) 130 and/or cache memory 132. Computer system/server 112 may further include other non-transitory removable/non-removable, volatile/non-volatile computer system storage media. By way of example, storage system 134 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of the embodiments. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of the embodiments. For example, a program module may be software for utilizing a dynamically adaptable rules and communication system to manage process control-based use cases.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

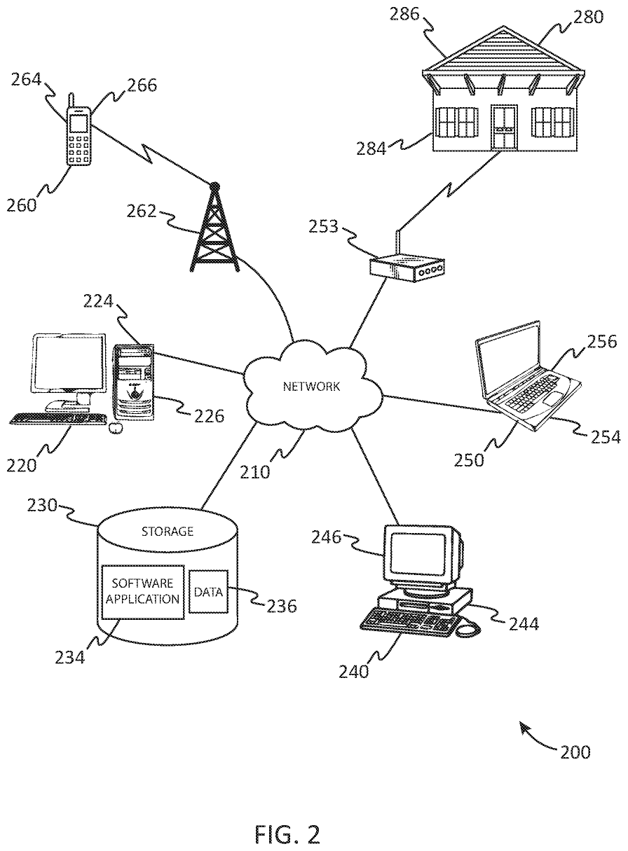

FIG. 2 provides a block diagram of an illustrative network of data processing systems in which various embodiments of the present disclosure may be implemented. Data processing environment 200 is a network of data processing systems such as described above with reference to FIG. 1. Software applications such as for utilizing a dynamically adaptable rules and communication system to manage process control-based use cases may be processed on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250 and facility 280 (such as a home or business) are coupled to network 210 including wirelessly such as through a network router 253. A mobile device 260 such as a mobile phone may be coupled to network 210 through a cell tower 262. Data processing systems, such as server 220, client 240, laptop 250, mobile device 260 and facility 280 contain data and have software applications including software tools processing thereon. Other types of data processing systems such as personal digital assistants (PDAs), smartphones, tablets and netbooks may be coupled to network 210.

Server 220 may include software application 224 and data 226 for utilizing a dynamically adaptable rules engine to manage process control-based use cases or other software applications and data in accordance with embodiments described herein. Storage 230 may contain software application 234 and a content source such as data 236 for utilizing a dynamically adaptable rules and communication system to manage process control-based use cases. Other software and content may be stored on storage 230 for sharing among various computer or other data processing devices. Client 240 may include software application 244 and data 246. Laptop 250 and mobile device 260 may also include software applications 254 and 264 and data 256 and 266.

Facility 280 may include software applications 284 and data 286 on local data processing equipment. Other types of data processing systems coupled to network 210 may also include software applications. Software applications could include a web browser, email, or other software application for utilizing a dynamically adaptable rules and communication system to manage process control-based use cases.

Server 220, storage unit 230, client 240, laptop 250, mobile device 260, and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile device 260 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 200 may also employ a service-oriented architecture where interoperable software components distributed across a network may be packaged together as coherent business applications.

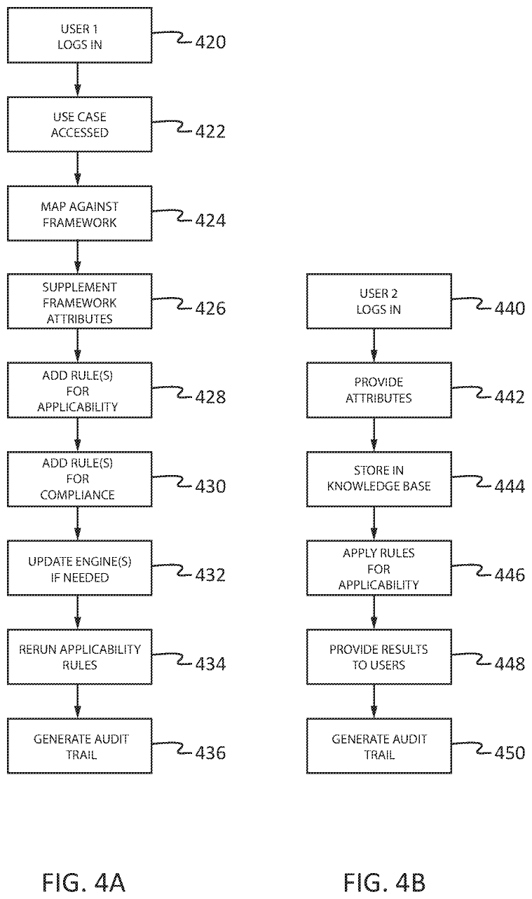

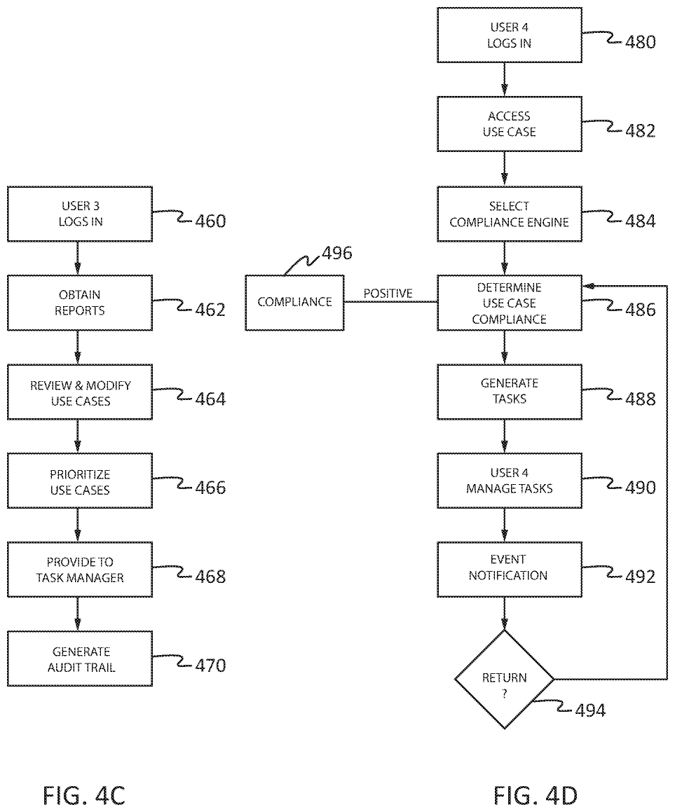

FIG. 3 provides a high-level block diagram of a dynamically adaptable rules and communication system, including multiple interacting modules 300 utilized to manage process control-based use cases, in which various embodiments of the present disclosure may be implemented. This dynamically adaptable rules and communication system includes a set of tiered and inter-connected methods and multiple, interconnected rules engines and databases such as described herein. This system is also a communications system, facilitating collaboration among multiple users in a structured but adaptable way, to create a more efficient, computer-enabled means of solving issues with managing applicability and compliance with process control-based use cases. High level flow diagrams for each of the multiple interacting modules are described below with reference to FIGS. 4A-4D. Interacting modules 300 include a system management module 320, a profile management module 340, a use case management module 360 and a task management module 380. At the core of these modules for the present embodiment is an adaptable applicability engine 301 which automatically applies a dynamic set of applicability rules 303 against a developing and dynamic knowledge base 305 to provide a set of applicable process control-based use cases 307. Applicable use cases 307 may be modified, prioritized and otherwise managed by User 3 in accordance with an intelligent governance, risk management and compliance (GRC) analysis towards generating and assigning a set of tasks 386 including tasks for implementing and verifying the process control-based use cases resulting in a determination of entity compliance and use case based program maturity. Applicable use cases 307 may be a database and may include use cases determined to be applicable or determined not to be applicable, whether by applicability engine 301 or by a managing user. Also at the core of these modules for the present embodiment is an adaptable compliance engine(s) 302 which applies a dynamic set of compliance rules 304 against developing and dynamic knowledge base 305 to provide a set of process control-based tasks 386 which may be modified, prioritized and otherwise managed in accordance with intelligent GRC analysis to bring the entity into compliance with applicable use cases and to verify that compliance. As described herein, snapshots of elements 301-309, as well as other elements described below, may be preserved as they are modified for a variety of uses such as for generating an audit trail.

The present embodiment is described as an automated rules and communication system for developing a model of an entity(ies) from both organization chart and business process data flow points of view in order automatically to determine the scope of laws, regulations, policies and other mandates (i.e., use cases) that apply to that particular entity. This model, also referred to herein as a knowledge base, as well as the rules to be applied against that model, may be developed and updated collaboratively among multiple users in a structured but adaptable manner. An entity may be a single entity or multiple interrelated entities combined and treated as a single entity for purposes of describing the present embodiment. In the case of multiple interrelated entities, each entity may also be treated as a single entity as described below, then the result combined to determine the use cases that apply to the combined entity. Also, for multiple entities, data for and processing of the present embodiment may be maintained on separate virtual systems or as isolated copies with firewalls in-between for each entity or group of entities so as to preserve the confidentiality of data from other entities or groups of entities.

System management module 320 includes a User 1 322 interacting with a graphical user interface (GUI) 324 to manage the various elements of system management module 320. As described in greater detail below with reference to FIG. 4A, User 1 322 may utilize User 1 GUI 324 to generate, based on incoming use case criteria and requirements 326 and existing framework 330, a set of applicability rules 303 and a set of attributes and queries 328 to determine applicability of the incoming use case to one or more entities as well as a set of compliance rules 304 to determine compliance of applicable use cases to one or more entities.

User 1 may be a single user, multiple users, a set of users with a given access profile, or other set of users authorized to utilize User 1 GUI 324. User 1 may also be the same as or separate from any other users (e.g., Users 2-4) shown herein. User 1 may also be from or support a different entity than other users. For example, User 1 may be from or supporting an entity managing software implementing this embodiment while other users may be from or supporting an entity applying the software implementing this embodiment to a specific entity. An entity may be a sole proprietorship, a partnership, a corporation or a set of interconnected entities such as a corporation and its subsidiaries. An entity also may be a set of processes performed by a generally defined set of users. A set of governing requirements for a use case 326 may be received, developed and/or approved by User 1 for generating of a set of applicability rules 303 and a set of attributes and queries 328 while utilizing framework 330. A use case may be a set of process controls or criteria (i.e., standards) to be met for a set of process controls for managing certain processes including regulatory, policy, contractual, code of other governing standard requirement such as privacy requirements, a set of governing standards received, generated and/or implemented by User 1, or other set of process control-based governing requirements. Use cases may include privacy laws (laws that deal with the regulating, storing and using of personally identifiable information of individuals), including the GDPR (General Data Protection Regulation) in Europe, CalOPPA (California Online Privacy Protection Act) in California, and numerous other privacy laws worldwide. Applicability rules 303 may be a set of rules to determine whether a use case applies to an entity based on that entity's profile and processes, such as described within knowledge base 305. Attributes and queries 328 may include a set of queries about an entity utilized for asking a user (such as User 2 as described below) to obtain a desired set of entity attributes. Attributes may include public or private information regarding an entity, such as annual revenue, number of employees, jurisdictions where the employees are located, types of data collected and stored from employees, customers and other users, where that data is stored and shared, data flows and processes utilizing that data, etc. That is, attributes may include various types of process data flows. For example, selling products in the European Union or collecting personal information from European Union residents may result in a determination that the GDPR use case applies. Such a determination of applicability may result in a task of documenting those process data flows to determine whether those process data flows are in compliance with the applicable GDPR use case rules.

Once these attributes have been documented, or as they are being documented, applicability rules 303 may then be applied to this obtained set of entity attributes to determine whether one or more use cases applies to an entity. Compliance rules 304 may then be applied to use cases by compliance engine 302 to generate tasks for moving towards compliance to the applicable use cases. Rules may be a logical expression for evaluating the application of a control or set of controls or whether a particular action or task is needed. Framework 330 may include a structured hierarchy of process controls that are common to a particular set of mandates, such as privacy or security, to which a variety of prior use cases have been applied. Often multiple use cases may utilize the same or similar criteria determining applicability or requirements for achieving compliance and Framework 330 provides a hierarchical listing of such criteria and requirements that can be cross-referenced and utilized across multiple use cases. Framework 330 may also include a set of prior applicability rules, attributes related to those prior use cases for possible utilization with an incoming use case. In an alternative embodiment, certain queries for eliciting input of certain attributes could be included in the framework so multiple entities could have a base of standard queries to work from in generating the queries in attributes and queries 328.

Profile management module 340 includes a User 2 342 interacting with a User 2 GUI 344 to manage the various elements of profile management module 340. As described in greater detail below with reference to FIG. 4B, User 2 342 may utilize User 2 GUI 344 to answer queries from attributes and queries 328 to generate an entity profile of attribute attributes for storage in knowledge base 305, thereby generating a model of the organizational structure and business process flows of the entity. Also, one or more test profiles may be generated that may be used as a scratchpad of possible entity attributes that can be utilized to run “what if” scenarios against applicability rules 303 by applicability engine 301. Applicability engine 301 may apply applicability rules 303 against the entity attributes stored in knowledge base 305 to generate dashboard 350 for feedback to User 2 as well as other users. User 2 may be a single user, multiple users, a set of users with a given access profile, or other set of users authorized to utilize User 2 GUI 344. User 2 may also be the same as or separate from any other users (e.g., Users 2-4) shown herein. Other users may also access User 2 GUI to manage profile management 340 as described herein.

Use case management module 360 includes a User 3 362 interacting with a User 3 GUI 364 to manage the various elements of use case management module 360. As described in greater detail below with reference to FIG. 4C, User 3 362 may utilize User 3 GUI 364 to manage the use cases including approving or rejecting use cases identified as applicable by applicability engine 301, adding additional use cases not identified as applicable by applicability engine 301, prioritizing use cases approved or added, as well as generating tasks pursuant to use cases approved or added by User 3. Use cases may be identified to User 3 for approval or rejection by applicability engine 301 through dashboard 350 or detail report 366. Snapshots of dashboard 350 and detail report 366 may be retained after each change to each of them, or upon each access or viewing of each of them by a user. Dashboard 350 may provide a different level of detail to User 2 and User 3. For example, User 3 may view a full assessment of use case applicability through dashboard 350 or that greater detail may be provided through detail report 366, whereas User 2 may only view a percentage of completion of the entity profile. As represented as a circled A, User 3 may also access User 2 GUI to make changes to the entity profile stored in knowledge base 305 based on the information received through dashboard 350 and detail report 366.

Task management module 380 includes a User 4 382 interacting with a User 4 GUI 384 to manage the various elements of task management module 380. As described in greater detail below with reference to FIG. 4D, User 4 382 may utilize User 4 GUI 384 to perform tasks derived from use cases provided by use case management module 360. This includes utilizing task manager 386 to invoke compliance engine 388 to generate a set of tasks 386 utilizing compliance rules 304. Tasks can include invoking a set of rules to determine the status of a given use case such as determining whether the entity is in compliance with a given use case, performing certain tasks to bring the entity partially or fully in compliance with the given use case, performing data flows for use in determining compliance with the given use case, etc. For example, a user may perform a DPIA (data protection impact assessment) as a task pursuant to a GDPR use case to achieve at least partial compliance with the GDPR use case. To complete any tasks, as represented as a circled A, User 4 may utilize User 2 GUI of data flow management module 340.

The automated rules and communication system described with reference to FIG. 3 is dynamic, adaptable and automated. The use case rules may be modified by User 1, resulting a different determination of use case applicability, which would be communicated with User 3 as described herein. The attributes of the entity may be modified or updated by User 2, also resulting in a different determination of use case applicability, which would also be communicated with User 3 as described herein. User 3 can also approve, add or remove certain use cases from applicability based on intelligent GRC analysis by User 3. In addition, User 3 may initiate a test environment whereby User 3 can make certain test modifications to the attributes of the entity to ascertain whether those modifications would result in different use case applicability. User 1 may also generate applicability rules for future or proposed use cases, which may then be applied against the entity attributes to determine whether the future or proposed use cases may be applicable to the entity. Of course, User 3 may initiate a test environment to identify impacts of modifications to the entity's attributes against the applicability rules for future or proposed use cases. All of these modifications by any of these users may result in an updated determination of use case applicability automatically. That is, use case applicability may be determined by the use case rules engine against the entity profile automatically, such as upon any modifications to the applicability rules by User 1, upon any modifications to the entity profile by User 3, upon the request of User 3, etc. Use case applicability may be determined upon any such modifications being provided by any of the users, upon the end of any user session, periodically, etc. based on update criteria set forth by User 3. As a result, with these capabilities, the automated rules and communication system is dynamic, adaptable and automated.

FIGS. 4A-4D provide high level flow diagrams for each of the multiple interacting modules utilized to manage process control-based use cases in which various embodiments of the present disclosure may be implemented. Although each flow diagram is described with reference to a single user or set of users, collaboration among these users is enabled and enhanced with the centralized databases, reports and other elements of the system described with reference to FIG. 3. While these flow diagrams are described with reference to a single use case, this process may be repeated for multiple use cases including utilizing previously generated elements pursuant to prior use case implementation. In addition, while these flow diagrams are described with reference to a single entity, this process may be repeated for multiple entities, particularly profile management module 340, use case management module 360 and task management module 380. The flow diagram shown in FIG. 4A may be utilized a single time for a given use case as the applicability rules and applicability engine modifications may be utilized across multiple entities or multiple use cases.

FIG. 4A is a high-level flow diagram of the operation of system management module 320 to manage process control-based use cases in which various embodiments of the present disclosure may be implemented. In a first step 420, User 1 logs into system management module 320 through GUI 324. This includes verifying the identity and access rights of User 1 to perform the following steps. User 1 may also be referred to herein as an administrative user. Although a single user GUI is shown in this module, multiple GUIs may be utilized for various aspects of system management module 320. In a second step 422, an incoming use case is received and accessed by User 1 through GUI 324 for application to one or more entities. This may be a new use case or an update to a previous use case. User 1 then uses GUI 324 in step 424 to access the framework for mapping the incoming use case against the framework. This includes identifying the various applicability criteria and process control requirements within the incoming use case and identifying where those elements were previously included in framework 330 (referred to herein as mapping the use case against the framework) as well as attributes and queries 328 from previous use cases and identifying gaps where new attributes and new process controls are included in the incoming use case for a given entity. In the example of the use case being laws, regulations, policies and other mandates that may apply to an entity, such as privacy rules, then the attributes and process control requirements for applicability can include queries and the results of those queries for analyzing an entity from both an organization chart and business process flow points of view in order to determine the scope of laws, regulations, policies and other mandates that apply to that entity. In step 426, the identified gaps for attributes and process controls may be added to framework 330 as well as attributes and queries 328. In addition, queries may be developed to supplement the attributes in attributes and queries. Then in step 428, a rule or set of rules for applicability of the use case are added or updated to applicability rules 303. Similarly, in step 430, a rule or set of rules for compliance are added or updated to compliance rules 304. Furthermore, applicability engine 301 and compliance engine 302 may be updated in step 432 if the new or updated applicability rules and compliance rules need additional or more complex processing by their respective engines. This process of mapping each use case against the framework results in filtering and supplementing framework 330 and attributes and queries 328 so that only those attributes needed for a set of use cases for a given entity are identified in attributes and queries for that given entity. In addition, this process may reduce or eliminate duplication of those attributes identified in the entity profile. This may reduce the number of total attributes needed for querying User 2 for that given entity such as described below. Furthermore, attributes and queries 328 may only include attributes needed for certain use cases. That is, a user such as User 3 may identify which use cases to be applied with a given entity, thereby possibly reducing the number of attributes and queries applied to that given entity and possibly reducing the number of use cases to be determined as applicable for that given entity by applicability engine 301.

Then in step 434, applicability engine 301 can be rerun with any updated applicability rules 303 utilizing the current knowledge base 305 to generate updated dashboard 350, detail report 366 and applicable use cases 307 for viewing and action by the other users. This may be rerun only for those applicability rules 303 and applicability engine 301 that have been updated through the above steps by User 1. Alternatively, applicability rules 303 and applicability engine 301 may only be rerun upon the request of User 3. Then in step 436, an audit trail of the attributes rules and attributes engines updates is preserved including the identity of User 1, either in the knowledge base as a snapshot or in a separate audit trail database. This audit trail may be generated concurrently with attributes data entry of step 432 or at the end of the attributes data entry session by User 1.

FIG. 4B is a high-level flow diagram of the operation of profile management module 340 to manage an entity profile including attributes of that entity in which various embodiments of the present disclosure may be implemented. An entity profile can be utilized across multiple use cases and may not need updating for each use case depending on whether the necessary attributes for that entity were previously provided. In a first step 440, User 2 logs into profile management module 340 through GUI 344. This includes verifying the identity and access rights of User 2 to perform the following steps. User 2 may also be referred to herein as a profile user. Although a single GUI is shown in this module, multiple GUIs may be utilized for various aspects of profile management module 340. In a second step 442, User 2 provides profile attributes of a specific entity through GUI 344, which may be in response to queries, fill in the blank, drop down menus, pop up boxes, etc. to provide the information needed for and as provided in attributes and queries 328. This step may include generating a new set of attributes for a new entity or updating a previous set of attributes for an existing entity. Alternatively, User 2 may be entering one or more test entity profiles suitable for running “what if” scenarios. A test profile may be created from scratch or by copying and modifying a previous entity or test profile. Attributes and queries 328 may also include explanations of the various attributes and their meaning within the context of one or more use cases. In the present embodiment, the results of answering these queries results in an entity profile from both an organization chart and business process flow points of view in order to determine the scope of laws, regulations, policies and other mandates that apply to that entity. In step 444, typically as the entity attributes are provided, they are stored as an entity profile generated in knowledge base 305. In step 446, which may occur concurrently and in real time as the entity attributes are provided by User 2 through GUI 344 in step 442, applicability engine 301 could be applying applicability rules 303 for one or more use cases against the generated or updated entity profile. In step 448, the results of applying the applicability rules against the entity profile are then provided in dashboard 350 and detail report 366. Either or both dashboard 350 and detail report 366 may be updated continuously as User 2 provides the entity attributes through GUI 344 or at the end of an attributes data entry session by User 2. User 2 may only have limited access to the dashboard and no access to the detail report to avoid influencing the data entered by User 2. That is, User 2 may be influenced by such feedback to modify entity attribute entry to either seek or avoid certain use case applicability. As a result, User 2 may only be provided in dashboard 350 with a percentage of completion of entity attributes needed to complete an entity profile. In step 450, an audit trail of the entity attributes provided and the identity of User 2 are also stored, either in the entity profile as a snapshot or in a separate audit trail database. This audit trail may be generated concurrently with attributes data entry of step 444 or at the end of the attributes data entry session by User 2.

FIG. 4C is a high-level flow diagram of the operation of use case management module 360 to manage use cases potentially applicable to an entity in which various embodiments of the present disclosure may be implemented. An entity profile can be utilized across multiple use cases and may not need updating for each use case depending on whether the necessary attributes for that entity were previously provided. In a first step 460, User 3 logs into use case management module 360 through GUI 364. This includes verifying the identity and access rights of User 3 to perform the following steps. User 3 may also be referred to herein as a managing user. As will be seen below, typically User 3 will have a higher level of access rights allowing User 3 to make use case applicability decisions as compared to User 2. For example, User 3 may be a chief privacy officer or chief compliance officer of an entity. Although a single GUI is shown in this module, multiple GUIs may be utilized for various aspects of use case management module 360. In a second step 462, User 3 can request and access applicability engine 301 and generate dashboard 350 and detail report 366 for a given entity. These reports may have already been generated pursuant to the last entity profile data entry session by User 2.

In a third step 464 User 3 may review the use cases identified as applicable by applicability engine 301 as well as use cases not identified as applicable for the entity. User 3 may then approve or modify the results of applicability engine 301. If User 3 modifies the results of applicability engine 301, User 3 may either select use cases as applicable or not regardless of whether they were deemed applicable or not by applicability engine 301. User 3 may also have an option to log into User 2 GUI for profile management module 340 to modify the entity attributes and profile. These modifications to the entity profile may alter which end cases are applicable for that entity. User 3 may also have an option to log into User 2 GUI for profile management module 340 to generate or modify a test version of the entity attributes and profile. A test profile can be managed similar to an entity profile by User 3 to determine use case applicability of that test profile. Then in step 466, User 3 may prioritize those use cases identified as applicable to the entity by User 3 (through approval or modification of the results of applicability engine 301). This prioritization may focus attention to and efforts for accomplishing tasks generated pursuant to the applicable higher priority use cases. Based on User 3's applicability approvals, modifications and prioritization, in step 468, the resulting set of use cases are provided to task management module 380 for determining and obtaining compliance to those use cases. As described below, this includes generating tasks that are prioritized based on the use case prioritization by task management module 380. In an alternative embodiment, some or all tasks could then be generated in the use case management module for approval and assignment to various individuals by User 3. In another alternative embodiment, a use case may be simulated in this module to identify the various tasks to be performed pursuant to that simulated use case in task management module 380. In step 470, an audit trail of the use cases provided, approved, modified and prioritized with the identity of User 3 are stored, either in the dashboard 350 as a snapshot or in a separate audit trail database. This audit trail may be generated concurrently with use case management by User 3 in steps 464 to 466 or at the end of the use case data management session by User 3.

FIG. 4D is a high-level flow diagram of the operation of task management module 380 to manage tasks potentially applicable to an entity in which various embodiments of the present disclosure may be implemented. In a first step 480, User 4 logs into task management module 380 through GUI 384. This includes verifying the identity and access rights of User 4 to perform the following steps. User 4 may also be referred to herein as a compliance user. Although a single user GUI is shown in this module, multiple GUIs may be utilized for various aspects of task management module 380. In a second step 482, an incoming use case is received and accessed by User 4 through GUI 384 for generation of one or more tasks. User 4 then uses GUI 384 in step 484 to select a compliance engine 302 for a given use case for a given entity. The use case may be the highest priority use case as determined by User 3 through GUI 364. There may be multiple compliance engines available for selection, typically one compliance engine per use case. However, one use case may have multiple sections, each section having a separate compliance engine. Alternatively, one compliance engine could be utilized for multiple use cases, particularly if those use cases are quite similar in scope and implementation. Typically, a compliance engine is selected by User 4 for a use case determined to be applicable, either by applicability engine 301 and approved or selected by User 3 through User 3 GUI. In step 486 User 4 then invokes compliance engine 302 for the selected use case(s) which then utilizes appropriate compliance rules 304 to determine whether the entity is in compliance with the use case. The determination of compliance engine 302 may be positive, negative, or more information needed. In each case, in step 488 certain tasks 386 may be generated by compliance engine 302 towards bringing the entity into compliance for the selected use case. These tasks may include performing a review or audit of certain processes, identifying certain data flows throughout the entity, require the creation and fulfillment of certain organization positions (i.e. a privacy officer), etc. User 4 can then manage these generated tasks in step 490 including assigning them to selected personnel for full or partial completion of those tasks. Once these tasks are partially or fully completed by the selected personnel, User 4 may be notified of this event in step 492 through User 4 GUI. In step 494, User 4 may then select to return to step 486 to again invoke compliance engine 302 upon this event to further determine entity compliance of the selected use case, which may result in a positive assessment of compliance in step 496 or the generation of additional tasks in step 488 towards achieving compliance of the selected use case.

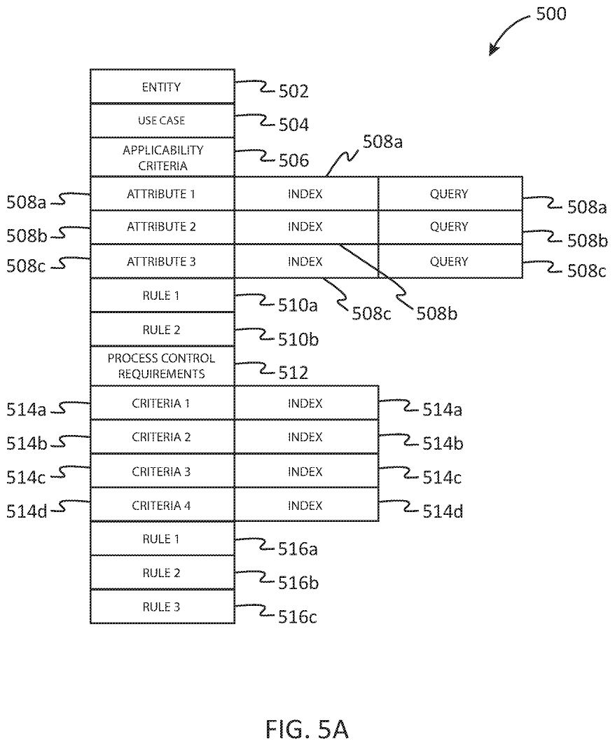

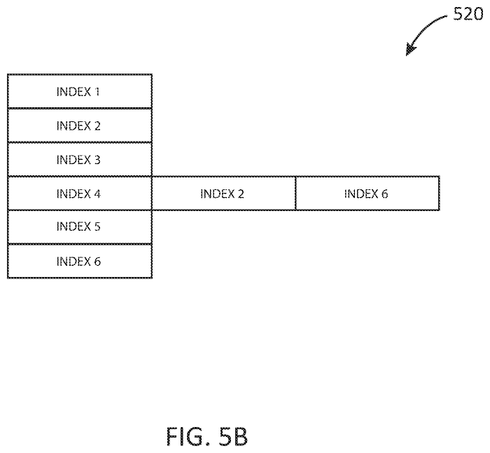

FIGS. 5A-5B provide block diagrams of database records utilized to manage process control-based use cases in which various embodiments of the present disclosure may be implemented. A record is a set of information within a domain or database that establishes a relationship between a set of data or data elements. A record may be a separate entry into a database, a set of links between data, or other logical relationship between a set of data.

FIG. 5A is a block diagram 500 of a set of records for a selected use case for a certain entity. Additional sets of records may be generated for additional use cases and additional entities. The embodiment shown here can be utilized by many elements described above with reference to FIG. 3 including applicability rules 303, attributes and queries 328 and applicability engine 301. Block diagram 500 includes an identified entity 502 and identified use case 504 for entity 502. Identified entity 502 may be an actual entity being modelled or it may be a test entity for performing “what if” scenarios. Use case 504 includes applicability criteria 506 for determining whether use case 504 is applicable for entity 502. Applicability criteria 506 can identify the number of attributes and rules needed to determine this use case applicability. In this example, there are three attributes 508a, 508b and 508c as well as two rules 510a and 510b. Each attribute can include a description of that attribute, an index to framework 330, and a query utilized to obtain the described attribute from the administrative user (e.g., User 1) as described above. The index to the framework may be all that is needed in this database to access the indexed attribute and corresponding query. Process control requirements 512 can identify the number of criteria and rules needed to determine whether entity 502 is in compliance with use case 504. Process control requirements 512 can identify the number of criteria and rules needed to determine this use case compliance. In this example, there are four criteria 514a, 514b, 514c and 514d as well as three rules 516a, 516b and 516c. Although only a few criteria and rules are shown for illustrative purposes, many more criteria and rules may be utilized for implementing an embodiment of the present invention.

FIG. 5B is a block diagram 520 of a set of records describing the hierarchical relationship among attribute indices to elements of framework 330 and attributes contained in attributes and queries 328. That is, each index refers to a particular attribute of an entity. As described above, attributes may include public or private information regarding an entity such as annual revenue, number of employees, jurisdictions where the employees are located, types of data collected and stored from employees, customers and other users, where that data is stored and shared, data flows and processes utilizing that data, etc. In this embodiment, each index to the framework can be listed including any parent indices for that index. For example, Index 1, index 2 and index 3 do not have any parent indices. However, Index 4 has two parent indices, Index 2 and Index 6. If two indices meet a certain criterion for determining applicability and one of these indices is a subset of or subservient to the other, then the other index is the parent index to the subset or subservient index. For example, if a first index refers to an entity having a privacy officer and a second index refers to an entity having a privacy officer that is also an attorney, the second index is a parent index to the first index. That is, the attribute referred to by the parent index will meet any condition or criteria met by the attribute referred by the first index. Although only a few indices are shown for illustrative purposes, many more indices may be utilized for implementing an embodiment of the present invention. Alternative embodiments may use other techniques for documenting this hierarchical relationship between attributes and indices. This can include the use of codes that indicate a hierarchical relationship. For example, code 1610 may be deemed a parent code to code 1612 as they both start with 161, and 0 can be designated as the parent to all other numbers 1-9. Alternative embodiments could utilize other types of data structures and coding schemes to document hierarchies among the indices.

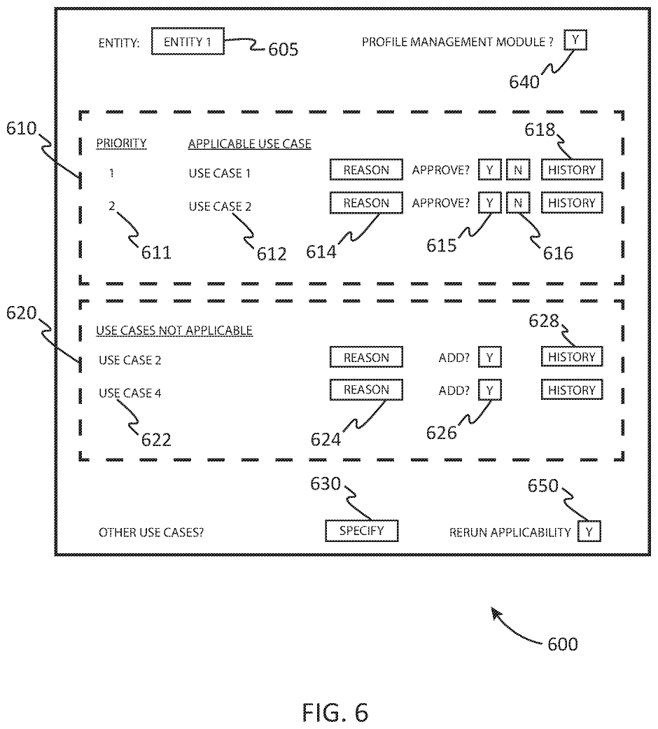

FIG. 6 provides a block diagram of a graphical user interface managing user may use to manage process control-based use cases in which various embodiments of the present disclosure may be implemented. This embodiment is described in support of User 3's (also referred to herein as the managing user) actions in flow diagram of FIG. 4C. In this embodiment, the managing user is able to check the applicability of use cases against various entities, including test entities, approve or remove certain use cases, prioritize the applicable use cases, log on the profile management module to modify an entity profile, and rerun the use case applicability determinations.

Graphical User Interface (GUI) 600 is accessible by the managing user as shown above with reference to User 3 of FIG. 4C. Other users may be able to utilize this GUI depending on the configuration of the system. GUI 600 includes a description of the entity 605. This description can be in a pull-down menu to allow the managing user to select other entities, such as test entities. A listing of all use cases deemed applicable to the entity, shown in entity description 605, are listed in applicable listing 610. Applicable listing 610 includes a priority of each use case 611, a description of each use case 612, reason for applicability box 614, approve applicability 615, remove applicability 616, and history 618. Description 612 describes the use case that has been deemed applicable. This may be a full use case such as GDPR, or it may be a portion of a use case with each applicable portion listed separately as applicable or not. Priority 611 is a priority assigned to each use case in moving towards achieving compliance. This can be utilized to prioritize any tasks identified from that use case towards achieving compliance of that use case. Prioritization may be modified the managing user by either changing the prioritization number directly or by selecting and moving lone use case line below or above another use case line. Reason box 614 can be selected to view the reason that use case was deemed applicable. Pressing or clicking reason box 614 can generate a pop-up box or other method for showing the detailed reasons the use case was deemed applicable. The managing user can then select approve applicability button 616 or remove applicability button 617 to either approve or remove a use case from applicability. A history of each use case may also be shown by selecting history button 618, allowing the managing user to view a history of the use case for this entity in a pop-up box or other method.

A listing of all use cases deemed not applicable to the entity, shown in entity description 605, are listed in not applicable listing 620. Not applicable listing 620 includes a description of each use case 622, reason for not applicable box 624, Add applicability 626, and previous status 628. Description 622 describes the use case that has been deemed not applicable. This may be a full use case such as GDPR, or it may be a portion of a use case with each non-applicable portion listed separately as applicable or not. In this embodiment, no priority is given for use cases deemed not applicable. Reason box 624 can be selected to view the reason that use case was deemed applicable. Pressing or clicking reason box 624 can generate a pop-up box or other method for showing the detailed reasons the use case was deemed applicable. The managing user can then select add applicability button 626 to add a use case as applicable. A history of each use case may also be also shown by selecting history button 624, allowing the managing user to view a history of the use case for this entity in a pop-up box or other method.

GUI 600 provides the managing user the capability of adding use cases not listed above in box 630. These may be use cases where there is not currently a set of rules for determining applicability. GUI 600 also provides a link 640 for the managing user to log onto Profile Management module 640. Also provided is a clickable button 650 for rerunning applicability engine 301. This can be useful after the managing user has made modifications to the entity profile or at other times convenient to the managing user. An additional link may be provided for the managing user to view various audit trails generated by the various processes described herein. Other users may also be given this capability, possibly some users with broader viewing rights, other users with narrower viewing rights.

As described above, various elements of FIG. 3 may access and utilize this database. For example, User 2 GUI may access the attributes and queries 508a-c, also shown as attributes and queries 328 in FIG. 3, for generating knowledge base 305. For another example, applicability engine 301 may access rules 510a-b, also shown as applicability rules 303, for determining whether use case 504 is applicable to entity 502.

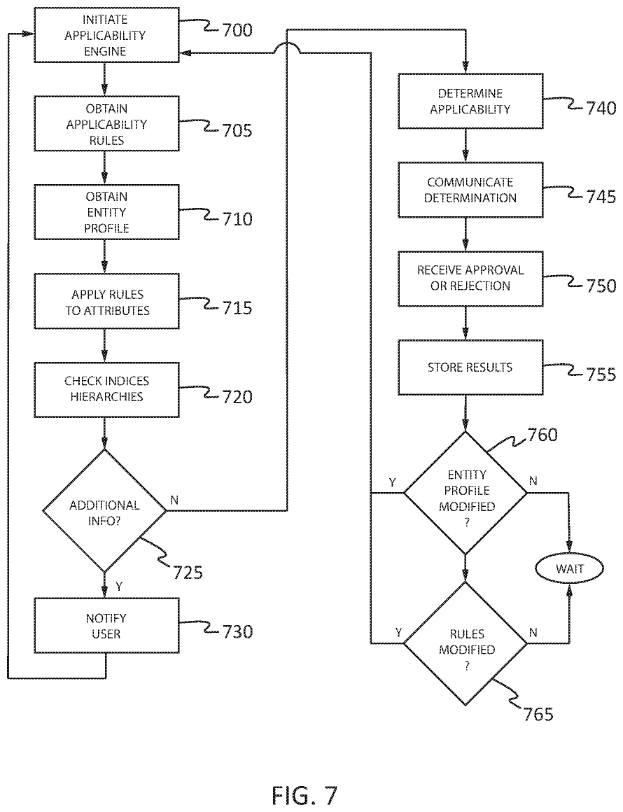

FIG. 7 provides a high-level flow diagram of the applicability engine managing process control-based use cases in which various embodiments of the present disclosure may be implemented. The operation of the applicability engine may be managed internally within the engine itself, or externally by a management element within the dynamically adaptable rules and communication system. This embodiment is directed to the operation of applicability engine 301 for a single entity, but could easily be extended to multiple entities. For example, in the case of multiple entities, the applicability engine may run for all entities for all use cases or for just those use cases that have had applicability rules changed. Similarly, if the entity profile changes for a single entity, then the applicability engine may run for all use cases for that entity. However, if the entity profile changes for multiple entities, then the applicability engine may run for all entities or for just those entities that have had their entity profiles changed. This embodiment is also directed to a set of use cases, which may include one or multiple use cases. For example, if the applicability rules change for a single use case, then the applicability engine may run only for that use case. However, if the applicability rules change for multiple use cases, then the applicability engine may run for all use cases or for just those use cases that have had applicability rules changed.

In step 700, applicability engine receives a request or is otherwise initiated by circumstances such as described below to make an applicability determination for a given set of use cases for a given entity. In the case of multiple use cases or multiple entities, the following could be performed for all those uses cases and entities. The applicability engine then requests and/or obtains a set of applicability rules for the given set of use cases in step 705. Then in step 710, the applicability engine then requests and/or obtains an entity profile for the given entity such as from a knowledge base for that entity. The set of applicability rules and the entity profile may have been generated as described above with reference to FIGS. 4A-4B. Then in step 715, the applicability engine applies the set of applicability rules against selected attributes of the entity profile. That is, only certain attributes of an entity may be needed for each set of applicability rules, so the applicability rules are applied against those needed attributes. In step 720, as the set of applicability rules are applied against the selected attributes of the entity profile, corresponding indices to the selected attributes are also checked in a hierarchical table of indices (also referred to herein as a hierarchy of indexed attributes) such as described above with reference to FIG. 5B. That is, an entity profile may not contain an exact attribute as needed in the applicability rules, but a higher level attribute may be in the entity profile that would meet the requirements of the applicability rules.

In step 725, the applicability engine indicates whether additional information is needed to make a determination of applicability. This can occur if there is missing information in the entity profile or other circumstances as set forth in the applicability engine. For example, additional tasks such as identifying certain data flows may be needed for making a determination of applicability. If yes in step 725, then in step 730 a managing user may be notified of this indication. The managing user can then correct the shortcoming directly or may generate a task requesting another user, such as a profile user, to correct this shortcoming. Processing can then return to step 700 until this shortcoming is corrected. If no in step 725, then processing continues to step 740.

In step 740, the applicability engine makes a determination of applicability in accordance with applicability rules and the entity profile. Applicability engine then provides a communication of this determination in step 745, such as to a managing user. This communication may be made through a dashboard, a report, stored in a database for later retrieval by a user or agent, etc. Upon providing the communication of this determination of applicability, in step 750, applicability engine awaits receiving an approval or rejection of this determination, such as from the managing user. Upon receiving an approval or rejection of the determination of applicability, the results are stored in a database of applicable use cases in step 755.

Then in step 760, the applicability engine awaits an indication that the entity profile has been modified. This could be a general indication of a modification to the entity profile or it could be a specific indication of a modification to an attribute needed for the applicability rules of the given set of use cases. If yes, then processing returns to step 700 above. In addition, in step 765, the applicability engine awaits an indication that the applicability rules for the given set of use cases have been modified. If yes, then processing returns to step 700 above. This indication of a modification to the entity profile or the applicability rules may be automatically provided to the applicability engine by the GUIs used to make these modifications, automatically by the modules storing the entity profile and the applicability rules, upon request of a user, as a result of a periodic query by the applicability engine, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction processing device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random-access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may be processed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may process the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which are processed via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which are processed on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more performable instructions for implementing the specified logical function(s). In some alternative implementations, the functions noted in the blocks may occur out of the order noted in the Figures. For example, two blocks shown in succession may, in fact, be processed substantially concurrently, or the blocks may sometimes be processed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or processing program code will include at least one processor coupled directly or indirectly to memory elements through a system bus. The memory elements can include local memory employed during actual processing of the program code, bulk storage media, and cache memories, which provide temporary storage of at least some program code in order to reduce the number of times code must be retrieved from bulk storage media during processing.

A data processing system may act as a server data processing system or a client data processing system. Server and client data processing systems may include data storage media that are computer usable, such as being computer readable. A data storage medium associated with a server data processing system may contain computer usable code such as for utilizing a dynamically adaptable rules and communication system to manage process control-based use cases. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A data processing system for determining applicability of a set of use cases to an entity, the data processing system comprising:
a processor; and
a memory storing program instructions which when processed by the processor perform the steps of:
receiving a dynamic profile of an entity, the profile including attributes of that entity;
receiving a dynamic set of applicability rules, each set of applicability rules corresponding to at least one of the set of use cases, for determining whether the set of use cases applies to the entity based on the attributes of that entity;
applying the dynamic set of applicability rules against the dynamic entity profile to determine whether the set of use cases is applicable to the entity;
upon a positive determination that the at least one of the set of use cases is applicable to the entity, notifying a managing user of the positive determination;
responsive to receiving an indication that the dynamic profile of the entity has been modified, automatically repeating the step of applying the dynamic set of applicability rules against the dynamic entity profile to determine whether the set of use cases is applicable to the entity and, upon the positive determination, automatically repeating the step of notifying the managing user; and
responsive to receiving an indication that the dynamic set of applicability rules has been modified, automatically repeating the step of applying the dynamic set of applicability rules against the dynamic entity profile to determine whether the set of use cases is applicable to the entity and, upon the positive determination, automatically repeating the step of notifying the managing user.

2. The data processing system of claim 1 further comprising:
identifying the relevant attributes needed of the entity for making the determination of applicability by each of the dynamic set of applicability rules corresponding the set of use cases;
generating the dynamic profile including the identified relevant attributes; and
obtaining the identified relevant attributes for the entity profile.

3. The data processing system of claim 1 further comprising:
receiving a first use case for generating a first set applicability rules;
identifying attributes needed for making a determination of applicability of the entity;
mapping the needed attributes against a framework of known attributes; and
utilizing the mapped known attributes for updating the relevant attributes of the entity.

4. The data processing system of claim 3 further comprising updating the framework with any needed attributes not found in the framework.

5. The data processing system of claim 1 wherein the step of applying the dynamic set of applicability rules against the dynamic entity profile includes checking a hierarchy of indexed attributes for determining applicability.

6. The data processing system of claim 1 further comprising:
determining whether sufficient information is found in the entity profile for making a determination of applicability; and
upon making a determination of insufficient information, automatically notifying the managing user for correction.

7. A computer program product for determining applicability of a set of use cases to an entity, the computer program product comprising a non-transitory computer readable storage medium having program instructions embodied therewith, the program instructions processed by a processing circuit to cause the device to perform a method comprising:
receiving a dynamic profile of an entity, the profile including attributes of that entity;
receiving a dynamic set of applicability rules, each set of applicability rules corresponding to at least one of the set of use cases, for determining whether the set of use cases applies to the entity based on the attributes of that entity;
applying the dynamic set of applicability rules against the dynamic entity profile to determine whether the set of use cases is applicable to the entity;
upon a positive determination that the at least one of the set of use cases is applicable to the entity, notifying a managing user of the positive determination;
responsive to receiving an indication that the dynamic profile of the entity has been modified, automatically repeating the step of applying the dynamic set of applicability rules against the dynamic entity profile to determine whether the set of use cases is applicable to the entity and, upon the positive determination, automatically repeating the step of notifying the managing user; and
responsive to receiving an indication that the dynamic set of applicability rules has been modified, automatically repeating the step of applying the dynamic set of applicability rules against the dynamic entity profile to determine whether the set of use cases is applicable to the entity and, upon the positive determination, automatically repeating the step of notifying the managing user.

8. The computer program product of claim 7 further comprising:
identifying the relevant attributes needed of the entity for making the determination of applicability by each of the dynamic set of applicability rules corresponding the set of use cases;
generating the dynamic profile including the identified relevant attributes; and
obtaining the identified relevant attributes for the entity profile.

9. The computer program product of claim 7 further comprising:
receiving a first use case for generating a first set applicability rules;
identifying attributes needed for making a determination of applicability of the entity;
mapping the needed attributes against a framework of known attributes; and
utilizing the mapped known attributes for updating the relevant attributes of the entity.

10. The computer program product of claim 9 further comprising updating the framework with any needed attributes not found in the framework.

11. The computer program product of claim 7 wherein the step of applying the dynamic set of applicability rules against the dynamic entity profile includes checking a hierarchy of indexed attributes for determining applicability.

12. The method of claim 7 further comprising:
determining whether sufficient information is found in the entity profile for making a determination of applicability; and
upon making a determination of insufficient information, automatically notifying the managing user for correction.

13. A method for determining applicability of a set of use cases to an entity comprising the steps of:
receiving a dynamic profile of an entity, the profile including relevant attributes of that entity;
receiving a dynamic set of applicability rules, each set of applicability rules corresponding to at least one of the set of use cases, for determining whether the set of use cases applies to the entity based on the attributes of that entity;
applying the dynamic set of applicability rules against the dynamic entity profile to determine whether the set of use cases is applicable to the entity;
upon a positive determination that the at least one of the set of use cases is applicable to the entity, notifying a managing user of the positive determination;
responsive to receiving an indication that the dynamic profile of the entity has been modified, automatically repeating the step of applying the dynamic set of applicability rules against the dynamic entity profile to determine whether the set of use cases is applicable to the entity and, upon the positive determination, automatically repeating the step of notifying the managing user; and
responsive to receiving an indication that the dynamic set of applicability rules has been modified, automatically repeating the step of applying the dynamic set of applicability rules against the dynamic entity profile to determine whether the set of use cases is applicable to the entity and, upon the positive determination, automatically repeating the step of notifying the managing user.

14. The method of claim 13 further comprising:
identifying the relevant attributes needed of the entity for making the determination of applicability by each of the dynamic set of applicability rules corresponding the set of use cases;
generating the dynamic profile including the identified relevant attributes; and
obtaining the identified relevant attributes for the entity profile.

15. The method of claim 13 further comprising:
receiving a first use case for generating a first set applicability rules;
identifying attributes needed for making a determination of applicability of the entity;
mapping the needed attributes against a framework of known attributes; and
utilizing the mapped known attributes for updating the relevant attributes of the entity.

16. The method of claim 15 further comprising updating the framework with any needed attributes not found in the framework.

17. The method of claim 13 wherein the step of applying the dynamic set of applicability rules against the dynamic entity profile includes checking a hierarchy of indexed attributes for determining applicability.

18. The method of claim 13 further comprising:
determining whether sufficient information is found in the entity profile for making a determination of applicability; and
upon making a determination of insufficient information, automatically notifying the managing user for correction.

19. The method of claim 13 further comprising:
receiving a communication from the managing user, responsive to the prior notification of the positive determination, of a set of use case related tasks assigned to a set of users; and
automatically notifying the set of users of the set of use case related tasks assigned to that set of users.

20. The method of claim 13 further comprising:
receiving a notification from the managing user, responsive to the prior notification of the positive determination, of a rejection of a use case from the at least one of the set of use cases determined to be applicable to the entity; and
indicating the rejected use case in a database of applicable use cases.
